(19) United States
(12) Patent Application Publication
(10) Pub. No.: US 2026/0079944 A1
(43) Pub. Date: Mar. 19, 2026

(54) DATABASE MANAGEMENT SYSTEM AND METHOD FOR EXECUTING QUERY PROCESSING TO DATABASE

(71) Applicant: Kioxia Corporation, Tokyo (JP)

(72) Inventor: Daiki WATANABE, Kawasaki (JP)

(73) Assignee: Kioxia Corporation, Tokyo (JP)

(21) Appl. No.: 19/066,411

(22) Filed: Feb. 28, 2025

(30) Foreign Application Priority Data
Sep. 13, 2024 (JP) 2024-159201

(51) Int. Cl. G06F 16/245; G06F 16/2455

(52) U.S. Cl. CPC G06F 16/24569; G06F 16/2455

(57) ABSTRACT

A database management system includes a processor and a memory, wherein the processor is configured to calculate features of each of a first node and a second node of a directed graph, calculate the feature of the first node by inputting the feature of the second node to be input to the first node to a first neural network that is dependent on an input order of the first node, and calculate the feature of the second node by inputting the feature of the first node to be input to the second node to a second neural network that is not dependent on an input order of the second node.

### CROSS REFERENCE TO RELATED APPLICATIONS

This application is based upon and claims the benefit of priority from the prior Japanese Patent Application No. 2024-159201, filed on Sep. 13, 2024, the entire contents of which are incorporated herein by reference.

### FIELD

An embodiment of the present disclosure relates to a database management system and a method for executing a query processing to a database.

### BACKGROUND

In recent years, a memory system equipped with a non-volatile memory has become widely used. For example, a memory system using a solid-state drive (SSD) is used as a data processing apparatus and a storage in a database management system.

The database management system executes a process in response to a query (process request). For example, in a relational database, an SQL query processing is executed. In the SQL query processing, a directed acyclic graph is used instead of a tree structure to optimize the query processing.

### BRIEF DESCRIPTION OF DRAWINGS

FIG. 1 is a block diagram showing a configuration of a system according to an embodiment.

FIG. 2 is a block diagram showing a configuration of a feature calculation unit according to an embodiment.

FIG. 3 is a diagram showing a directed graph according to an embodiment.

FIG. 4 is a diagram showing a directed graph according to an embodiment.

FIG. 5 is a diagram showing a directed graph according to an embodiment.

FIG. 6 is a flowchart for executing a query processing in a system according to an embodiment.

FIG. 7 is a diagram showing a result of calculating a feature of each node in a directed graph according to an embodiment.

FIG. 8 is a diagram showing a directed graph according to an embodiment.

### DESCRIPTION OF EMBODIMENTS

A database management system managing a database according to an embodiment of the present invention includes: a processor; and a memory, wherein the processor is configured to execute a query processing to the database using a directed graph according to a query received from a host, the directed graph being created based on the query, the directed graph includes: one or more first nodes corresponding to a process included in the query processing; one or more second nodes corresponding to a process result of the first node; and an edge indicating an input and an output to the first node and the second node, the processor is configured to: calculate features of each of the first node and the second node; calculate the feature of the first node by inputting the feature of the second node to be input to the first node to a first neural network that is dependent on an input order of the first node; and calculate the feature of the second node by inputting the feature of the first node to be input to the second node to a second neural network that is not dependent on an input order of the second node.

A method for executing a query processing to a database using a directed graph according to a query received from a host according to an embodiment of the present invention, wherein the directed graph includes: one or more first nodes corresponding to a process included in the query processing; one or more second nodes corresponding to a process result of the first node; and an edge indicating an input and an output to the first node and the second node, the method comprising: creating the directed graph based on the query; calculating features of each of the first node and the second node; calculating the feature of the first node by inputting the feature of the second node to be input to the first node to a first neural network that is dependent on an input order of the first node; and calculating the feature of the second node by inputting the feature of the first node to be input to the second node to a second neural network that is not dependent on an input order of the second node.

A database management system according to an embodiment of the present invention includes: a directed graph generating unit; a feature calculating unit; and a query processing executing unit configured to execute a query processing to the database according to a query received from a host, wherein the directed graph generating unit is configured to create a directed graph based on the query, the directed graph includes: one or more first nodes corresponding to a process included in the query processing; one or more second nodes corresponding to a process result of the first node; and an edge indicating an input and an output to the first node and the second node, the feature calculating unit is configured to: calculate features of each of the first node and the second node; calculate the feature of the first node by inputting the feature of the second node to be input to the first node to a first neural network that is dependent on an input order of the first node; and calculate the feature of the second node by inputting the feature of the first node to be input to the second node to a second neural network that is not dependent on an input order of the second node.

According to the database management system and the method for executing the query processing to the database, it is possible to provide a method for optimizing the query processing in the database management system.

Hereinafter, a database management system according to an embodiment will be specifically described with reference to the drawings. In the following description, components having substantially the same functions and configurations are denoted by the same reference signs, and redundant description may be omitted. Each of the embodiments described below exemplifies an apparatus and a method for embodying a technical idea of the embodiments. The technical idea of the embodiment is not limited to the following materials, shapes, structures, arrangements, and the like of the components. Various modifications may be made to the technical idea of the embodiment in addition to the scope of the claims.

In the following description, a “directed graph” is a technique in which, when there is a plurality of processes having a dependency relationship in a process executed in accordance with a query, information related to costs necessary for each process is held, and the relationships (preceding and succeeding relationships) of the plurality of processes are connected by arrows to be expressed as a directed graph. For example, the plurality of processes having a dependency relationship means a relationship in which the process C cannot be executed unless the process A and the process B are completed when the processes A, B, and C are present in the directed graph.

In the directed graph, a block corresponding to each process is referred to as a “node.” The contents of each process and the results obtained by the process are defined in the node. That is, the plurality of processes and process results included in the query processing correspond to a plurality of nodes in the directed graph, respectively. In other words, the process and the process results have a one-to-one relationship with the node. The directed graph includes an AND node and an OR node. The AND node is a node corresponding to the process included in the query processing. The OR node is a node corresponding to the process result of the AND node. Costs such as the time required for processing at each node, used memory capacity, power, and the usage fees of a server are collectively referred to as a “process cost.” An arrow indicating the relationship between the nodes is referred to as an “edge.” That is, the edge indicates the input and output for each node.

A “database” refers to a set of structured databases, including a relational database (RDB) or other databases (NoSQL). The “relational database” is a database configured to use multiple pieces of data in a tabular format in association with each other. The operation commands for the relational database are written in a database language. For example, a structured query language (SQL) is used as the database language. The database is operated by the SQL, and the data stored in the database is added, deleted, and searched (retrieved).

The “NoSQL” is a variety of databases other than the relational database. For example, the NoSQL may be a Key-Value database that holds a set of key-value pairs. This type of NoSQL can be operated using a unique language, for example, such as CQL in Apache Cassandra. In the following description, an operation group that a user wants to perform on a database is defined by a SQL or the like and is simply referred to as a “query,” and a process executed according to the query is referred to as a “query processing.” That is, the query processing includes the plurality of processes.

A “Physical property” or “property” indicates, for any AND node in the directed graph, where a process related to the node is physically executed, and in what state (for example, a compressed state or an uncompressed state) the input/output data is handled in the process. Similarly, the “physical property” or “property” indicates, for any OR node in the directed graph, where the data associated with the node is physically stored, and in what state (for example, a compressed state or an uncompressed state) the data is in in the process. That is, the physical property is given to the process contents included in the directed graph and the process result obtained by the process. The physical property is used to identify processes that perform mathematically identical operations but is executed at physically different positions, or to identify data that is mathematically identical but is stored at physically different positions in different states.

For example, in the case where the relational database is configured with a plurality of information processing terminals (e.g., a plurality of servers) and each of the plurality of servers includes a plurality of storage devices (e.g., SSD (Solid State Drive), DRAM (Dynamic Random Access Memory), and CPU (Central Processing Unit), the physical property includes information specifying a server and a storage device in which a corresponding process result is stored. As described above, the “physical property” is represented in a format that includes the concept of a data format.

### 1. First Embodiment

A database management system 10 according to the first embodiment will be described. For example, the database management system 10 according to the first embodiment is a relational database. The database management system 10 communicates with a host 20, receives a command including a query from the host 20, and implements a function of the relational database in response to the query.

### [1-1. Overall Configuration of Database Management System]

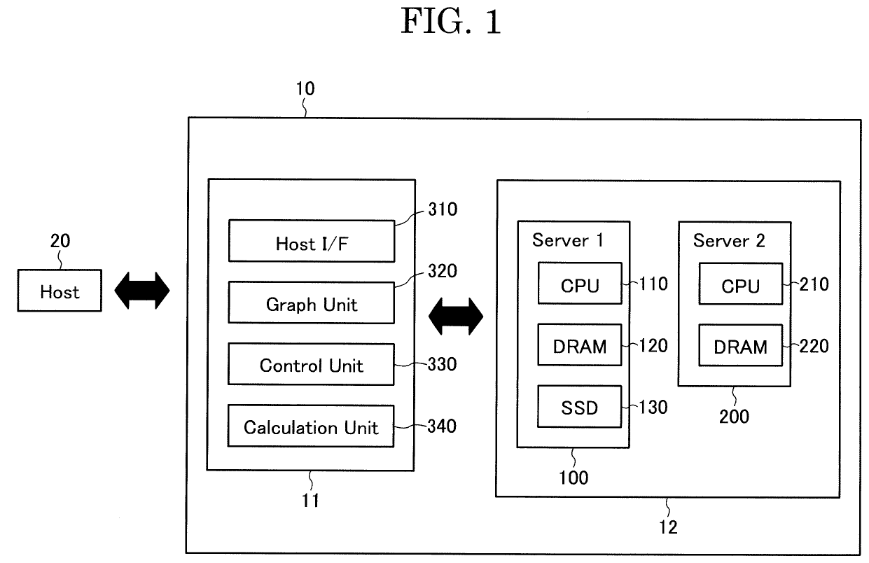

FIG. 1 is a block diagram showing a configuration of a database management system according to an embodiment. As shown in FIG. 1, the database management system 10 includes a management server 11 and a query processing execution unit 12.

The management server 11 includes a host interface 310 (Host I/F), a directed graph generation unit 320 (Graph Unit), a control unit 330 (Control Unit), and a feature calculation unit 340 (Calculation Unit). The management server 11 controls the query processing execution unit 12 using the directed graph described below by causing these functional units to cooperate with each other.

Each of the functional units of the host interface 310, the directed graph generation unit 320, the control unit 330, and the feature calculation unit 340 may be implemented by hardware, software, or a combination of both. It is not essential that the process contents in the respective functional units are clearly distinguished as the host interface 310, the directed graph generation unit 320, the control unit 330, and the feature calculation unit 340. Some processes of the plurality of processes may be executed by another functional unit, or each functional unit may be divided into more detailed elements. For example, some or all of these functions may be realized by at least one of a register, a memory, an adder, a multiplier, a selector, and other calculation units. For example, the register is realized by a sequential circuit such as a flip-flop. The adder, the multiplier, the selector, and the like are implemented by a combinational logic circuit. Some or all of these functions may be executed by one or more processors. That is, the database management system 10 (in particular, the management server 11) may include the processor and the memory, and the processor may realize some or all of the functions described above using the programs and data stored in the memory.

The host interface 310 executes a process according to the interface standard between the host 20 and the host interface 310. The host interface 310 transmits commands and the like received from the host 20 to the directed graph generation unit 320 and the control unit 330 through an internal bus. For example, the host interface 310 transmits the result of the operation executed according to the query to the host 20.

The directed graph generation unit 320 generates a directed graph based on the query received from the host 20. For example, the directed graph generation unit 320 analyzes the query, identifies the plurality of processes included in the query, and generates and deforms a directed graph based on the dependency relationships of the plurality of processes. The method for generating and deforming the directed graph will be described later.

Based on the directed graph generated by the directed graph generation unit 320 and the features (which will be described later) for each process, the control unit 330 determines an execution path in which the query processing is efficiently executed to the directed graph. Alternatively, the control unit 330 calculates a process cost for each process based on the directed graph and the feature, and determines the execution path in which the query processing is efficiently executed to the directed graph based on the process cost.

In other words, the control unit 330 determines one execution path from a plurality of execution paths, generates an execution plan of the query processing, and drives the query processing execution unit 12 based on the execution plan. The above-described process can be referred to as a process for optimizing the method for executing the query processing to the database using the directed graph. A method for calculating the feature, a method for calculating the process cost, and a method for optimizing the method for executing the query processing will be described later. In addition, optimization using a directed graph may mean selecting the most suitable one from among all candidates (for example, the one having the highest process efficiency), but it is not necessary to select the most suitable one, and it may mean selecting the one having a relatively high process efficiency from among a plurality of candidates.

The above-described optimization means selecting a process path derived from a feature in each node, the process path having a relatively high efficiency among a plurality of process paths on the directed graph, or the process path having a relatively low process cost (for example, the process time derived from the calculation of the process cost is relatively short). Specifically, the optimization may mean selecting a process path having the highest efficiency or a process path having the lowest process cost (the shortest process time) among the plurality of process paths on the directed graph. However, the meaning of the optimization is not limited to these examples. Specifically, a process path other than the above may be selected in accordance with a condition set in advance by the database management system 10, the host 20, or a user requesting the query processing.

The feature calculation unit 340 calculates the feature of each node in the directed graph using a neural network, and stores the calculated feature. Although details will be described later, the feature calculation unit 340 calculates the feature using a different neural network depending on the node type. Specifically, in the case where the feature calculation unit 340 calculates the feature of the AND node, the feature calculation unit 340 inputs the feature of the OR node to be input to the AND node to a first neural network process unit NN1 that is dependent on the order of the input (input order) of the AND node, and performs the calculation. On the other hand, in the case where the feature calculation unit 340 calculates the feature of the OR node, the feature calculation unit 340 inputs the feature of the AND node to be input to the OR node to a second neural network process unit NN2 that is not dependent on the input order of the OR node, and performs the calculation.

The first neural network process unit NN1 and the second neural network process unit NN2 may be arranged in the feature calculation unit 340, or may be arranged in a data processing apparatus different from the feature calculation unit 340, that is, in a data processing apparatus different from the management server 11. The first neural network process unit NN1 and the second neural network process unit NN2 may be arranged in the same data processing apparatus, or may be arranged in different data processing apparatuses.

The query processing execution unit 12 includes a first server 100 (Server 1) and a second server 200 (Server 2). The query processing execution unit 12 causes the first server 100 and the second server 200 to cooperate with each other to realize an operation (query processing) on the database in response to the query received from the host 20.

The first server 100 is a storage server for storing data. The first server 100 include a CPU 110, a DRAM 120 and an SSD 130. For example, the CPU 110 includes a cache memory such as an SRAM (Static Random Access Memory). In the following description, when data is stored in the SRAM of the CPU 110, it is expressed as the data is stored in the CPU 110. That is, the first server 100 can store the data in the CPU 110, the DRAM 120 and the SSD 130.

The second server 200 is a server for a computing process. The second server 200 includes a CPU 210 and a DRAM 220. The second server 200 is a server with high computing processing capability, so that a storage device such as the SSD is not included. Similar to the CPU 110, the CPU 210 also includes a cache memory such as the SRAM. In the following description, when data is stored in a register or the SRAM of the CPU 210, it is expressed as the data is stored in the CPU 210. In other words, the second server 200 can store the data in the CPU 210 and the DRAM 220. The CPU 210 can execute the computing process faster than the CPU 110. The capacity of the DRAM 220 is greater than the capacity of the DRAM 120. In addition, the second server 200 may include the SSD.

Similar to the management server 11, some or all of the functions of the query processing execution unit 12 may be executed by one or more processors. That is, the query processing execution unit 12 may include a processor and a memory, and the processor may realize some or all of the functions described above by using the programs and data stored in the memory.

### [1-2. Configuration of Feature Calculation Unit]

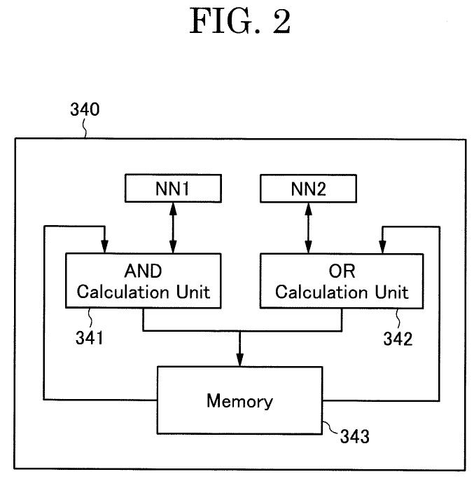

FIG. 2 is a block diagram showing a configuration of a feature calculation unit according to an embodiment. As shown in FIG. 2, the feature calculation unit 340 includes an AND node feature calculation unit (AND Calculation Unit) 341, an OR node feature calculation unit (OR Calculation Unit) 342, a feature memory (Memory) 343, the first neural network process unit NN1, and the second neural network process unit NN2. The AND node feature calculation unit 341 calculates the feature of the AND node by inputting the feature of the OR node to the first neural network process unit NN1. The OR node feature calculation unit 342 calculates the feature of the OR node by inputting the feature of the AND node to the second neural network process unit NN2.

The features calculated by the AND node feature calculation unit 341 and the OR node feature calculation unit 342 are transmitted to the feature memory 343 and stored in the feature memory 343. The feature of the AND node output from the feature memory 343 is input to the OR node feature calculator 342. The feature of the OR node output from the feature memory 343 is input to the AND node feature calculator 341.

First, the second neural network process unit NN2 will be described. The second neural network process unit NN2 performs a process using a neural network that is not dependent on the order of inputs. That is, when there are 2 inputs, an input 1 and an input 2, for the second neural network process unit NN2, the second neural network process unit NN2 outputs the same result even if the order of the input 1 and the input 2 is changed. In other words, the second neural network process unit NN2 performs a process using an “order invariant” neural network. For example, the second neural network process unit NN2 performs a process using the “Graph Neural Network.”

With respect to the second neural network process unit NN2, if the feature vectors for the input 1 and the input 2 are a first input feature vector x₁ and a second input feature vector x₂, respectively, and the weight matrix is W_{shared}, and the post-process (activation function) is f₂, a feature y₂ calculated by the second neural network process unit NN2 is obtained by Equation 1 below. In this case, f₂ is, for example, a sigmoid function or a ReLU function.

$${Y}_{2} = {f}_{2} ( {x}_{1} \times {W}_{shared} + {x}_{2} \times {W}_{shared} ) \qquad ( Equation 1 )$$

In Equation 1, the weight matrix W_{shared} for the two inputs are the same. Therefore, even if the order of the input 1 and the input 2 is changed (even if the first input feature vector x₁ and the second input feature vector x₂ are changed in Equation 1), the calculated feature y₂ does not change.

For example, the “Graph Attention Network” is used as an example of the second neural network process unit NN2. The Graph Attention Network includes a multi-head attention layer. Multi-head attention is a block component that executes a plurality of attention heads to convert each token representation in a sequence.

On the other hand, the first neural network process unit NN1 performs a process using a neural network that is dependent on the order of the inputs of the first node. That is, in the case where there are 2 inputs, the input 1 and the input 2, for the first neural network process unit NN1, and when the order of the input 1 and the input 2 is interchanged, the first neural network process unit NN1 outputs a different result. The first neural network process unit NN1 performs a process using a common neural network other than the second neural network NN2. For example, the first neural network process unit NN1 is the “Feedforward Neural Network.”

The Feedforward Neural Network is a neural network in which all the fully connected layers are connected. The fully connected layer is a layer that connects all nodes in the neural network. The neural network of the second neural network process unit NN2 is referred to as an “order invariant” neural network, and the neural network of the first neural network process unit NN1 is referred to as an “order dependent” neural network.

With respect to the first neural network process unit NN1, if the feature vectors for the input 1 and the input 2 are the first input feature vector x₁ and the second input feature vector x₂, the weight matrixes for the input 1 and the input 2 are the first weight matrix W₁ and the second weight matrix W₂, respectively, the post-process (activation function) is f₁, and the feature y₁ calculated by the first neural network process unit NN1 is obtained by Equation 2 below. In this case, f₁ is the sigmoid function or the ReLU function as in f₂.

$${y}_{1} = {f}_{1} ( {x}_{1} \times {W}_{1} + {x}_{2} \times {W}_{2} ) \qquad ( Equation 2 )$$

In Equation 2, the first weight matrix W₁ and the second weight matrix W₂ are different. Therefore, when the order of the input 1 and the input 2 is changed (when the first input feature vector x₁ and the second input feature vector x₂ are interchanged in Equation 2), the calculated feature y₁ changes.

Although details will be described later, the AND node is dependent on its input order, as described above. Therefore, the feature of the AND node is calculated by the first neural network process unit NN1 having a dependency on the input order. In other words, in the case where there is a plurality of inputs to the AND node and when the order of the inputs changes, the calculated feature also changes. On the other hand, although details will be described later, the OR node is not dependent on its input order. Therefore, the feature of the OR node is calculated by the second neural network process unit NN2 that is not dependent on the input order. In other words, in the case where there is a plurality of inputs to the OR node, the calculated feature does not change even if the order of the inputs changes.

In addition, the above-described methods for calculating the first neural network process unit NN1 and the second neural network process unit NN2 are merely examples and can be calculated by various other methods.

### [1-3. Directed Graph]

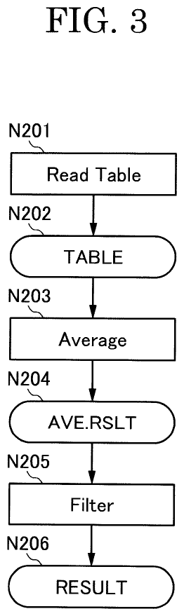

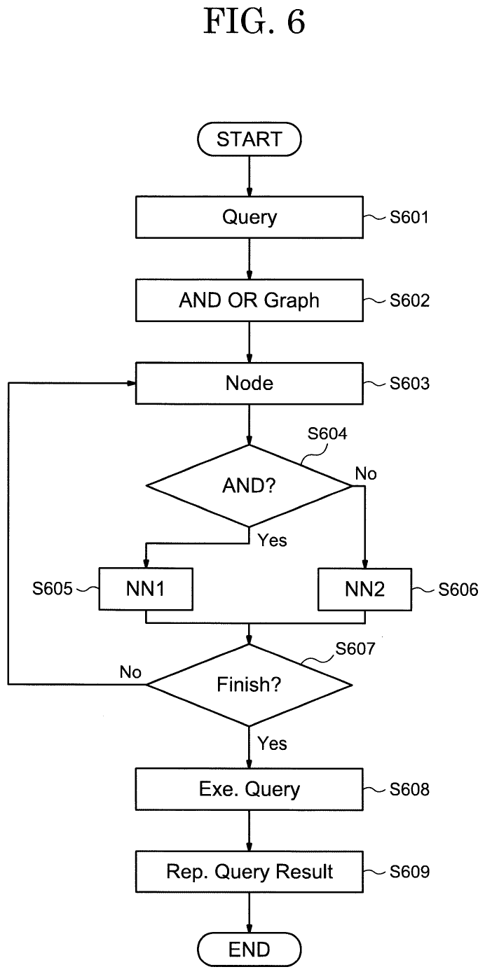

The directed graph will be described with reference to FIG. 3 to FIG. 6. FIG. 3 to FIG. 5 are diagrams showing a directed graph according to an embodiment. FIG. 6 is a diagram showing the results of calculating the feature of each node in the directed graph according to an embodiment. These diagrams will be used to describe the directed graph and the process in which the directed graph generation unit 320 generates the directed graph based on the query received from the host 20. The directed graph described in the present embodiment is a directed acyclic graph.

FIG. 3 shows the default process order before performing the deformation of the directed graph. In the case where the database management system 10 receives the above-described query from the host 20, first, the directed graph shown in FIG. 3 is generated. In the query processing shown in FIG. 3, the process described in the query is executed in a predetermined device (server) in the order described. For example, in FIG. 3, each process is executed to the first server 100.

In this example, as the query processing, an example is shown in which the data recorded in a table included in the database is read (N201; Read Table), average values for data matching a specific condition are calculated for the read data (N202; TABLE) for each condition (N203; Average), and, for the calculation results (N204; AVE. RSLT), only data in the case where the condition used for calculating the average values are included in a certain range is filtered (N205; Filter) and output (N206; RESULT).

For example, it is assumed that the table included in the database stored in the SSD 130 of the first server 100 contains a large amount of data of employees of a company. In this case, in N201, data of employees is read from the table stored in the SSD 130, and the read result is output to the N202 and stored in the DRAM 120 of the first server 100. The data is then transferred from the DRAM 120 to the CPU 110.

In N203, the CPU 110 of the first server 100 performs a process for calculating the “average amounts of salaries for each joining year” to the data input from N202, and in N204, the calculated average amounts of salaries are stored as the calculation results in the DRAM 120. Then, in N205, only the data of the joining year after the minimum joining year given as a parameter for the filtering process is output relative to the average amounts of salaries stored in the DRAM 120, and the output data is stored in the DRAM 120 as the calculation results in N206. In other words, an example in which average amounts of salaries for each joining year are output for employees who joined the company after a certain joining year as the final result (N206) is shown in FIG. 3.

In FIG. 3, the respective blocks N201 to N206 are the nodes. Among the plurality of nodes, the node indicated by a rectangular block is the AND node, and the node indicated by a substantially elliptical block is the OR node. The arrows connecting the blocks are edges. The edges indicate the input and output for the AND node and the OR node.

For example, the AND node includes a reading process for data, an aggregating process such as average and sum for data, a filtering process for data, a joining process for data, and the like. In FIG. 3, N201, N203, and N205 are the AND node.

For example, the OR node may include the results such as the result read from the table, the result of aggregating such as averages and sums, the result of filtering data, the result of joining data, and the like. Furthermore, in the case where the process result of two or more AND nodes is equivalent, only one OR node corresponds to the AND node with the plurality of equivalent outputs. In FIG. 2, N202, N204, and N206 are the OR node.

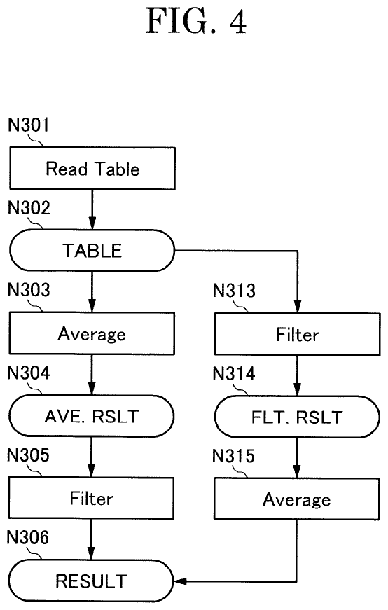

FIG. 4 shows a directed graph in the case where a logical deformation is executed to a default directed graph. The logical deformation means a deformation of a directed graph to which a deformation rule related to interchanging the execution order of processes and the like is applied. In this case, in order to obtain a logically equivalent final result, a plurality of paths in which the order of processes of the AND nodes is changed is derived.

As shown in FIG. 4, since the order of the read operation on the table cannot be changed, similar to N201 and N202 of FIG. 3, the read operation on the table (N301; Read Table) outputs the read result (N302; TABLE). On the other hand, under the condition of the present query processing, the order of the calculation process for the average values and the filtering process can be interchanged, so that the output from N302 branches into two types: N303 and N313.

Since N303 to N305 are the same as N203 to N205 of FIG. 3, the description will be omitted. In FIG. 4, the paths of N313 to N315 are arranged in parallel with the paths of N303 to N305.

In the paths of N313 to N315, only the data of the joining year after the minimum joining year given as the parameter of the filtering process is filtered (Filter; N313) for the read data (TABLE; N302), and for the filtered result (FLT. RSLT; N314), average values for the data that match the conditions used in the filtering process are calculated for each condition (Average; N315) and is output (RESULT; N306).

By way of example, in N313, the CPU 110 outputs only data for the joining year after the minimum joining year given as the parameter of the filtering process with respect to the data input from N302, and in N314, the output data is stored in the DRAM 120 as the calculation result of N313. In N315, a process for calculating average amounts of salaries for each joining year is performed on the data stored in the DRAM 120 in N314, and in N306, the calculated data is stored in the DRAM 120 as the calculation result of N315.

As described above, even in the paths of N303 to N305 or the paths of N313 to N315, average amounts of salaries for each joining year are output for employees who joined the company after a certain joining year as the final result (N306). In other words, N306 (OR node) is a result obtained by a logically equivalent process. Although these paths are logically equivalent, the process rate and the process amount of the CPU may be different depending on the order of the process. Therefore, the feature of each node can be calculated for these paths, and the method for executing the query processing can be optimized based on the calculated feature.

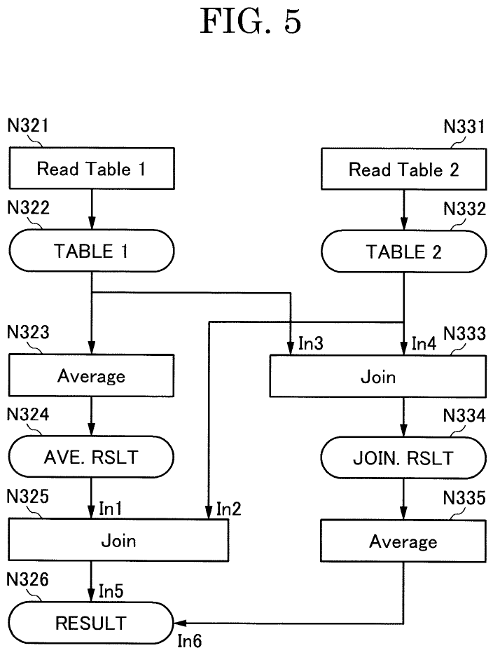

In the directed graphs of FIG. 3 and FIG. 4, a configuration in which one edge corresponds to the input of each AND node (for example, a configuration in which only one edge from N304 is connected to N305) has been simply exemplified, but as shown in FIG. 5, two edges may correspond to the input of each AND node. FIG. 5 exemplifies a configuration in which two pieces of data are input to the nodes (N325 and N333) related to the joining process (Join). In FIG. 4, data is read from one table, whereas in FIG. 5, as shown in N321 (Read Table 1) and N331 (Read Table 2), data is read from two different tables. Except for the above points, N323 to N325 of FIG. 5 are similar to N303 to N305 of FIG. 4, and N333 to N335 of FIG. 5 are similar to N313 to N315 of FIG. 4.

In FIG. 5, an input In1 and an input In2 are input to N325 that is the AND node. Similarly, an input In3 and an input In4 are input to N333 that is the AND node. The inputs In1 and In3 are inputs of the data on which the joining process is to be performed. The inputs In2 and In4 are inputs of data related to the conditions for executing the joining process. In other words, based on the query processing, the data related to the conditions for performing the joining process is read from the data recorded in the table (N331; Read Table 2) and output (N332; TABLE 2).

The AND node in which two pieces of data are input as described above will be described using a specific example. As described above, the data for the joining year after a certain base joining year are joined in N325. In other words, the base joining year corresponds to the “minimum joining year of employees to be included in the calculation.” Therefore, in the input In2 of N325 and the input In4 of N333, data related to the “minimum joining year of employees to be included in the calculation” (hereinafter referred to as “process condition data”) is input. In addition, since the “data related to the average amounts of salaries for each joining year” input in the input In1 of N325 and the input N333 in the input In3 is subjected to the process executed in N325 and N333, the data can be referred to as “process target data.” In this case, the reading of the data from the table (N331; Read Table 2) corresponds to reading the data from a small table including the process condition data (the minimum joining year of employees to be included in the calculation), and the read data (N332; TABLE) corresponds to the process condition data.

As described above, in N325 and N333, the process target data is input as the inputs In1 and In3, and the process condition data is input as the inputs In2 and In4. The process condition data is data indicating a condition for executing the joining process in N325 and N333 as described above. Therefore, when the process target data is input to the inputs In1 and In3 and the process condition data is input to the inputs In2 and In4, the data after the minimum joining year to be included in the calculation is output to the “data related to the average amounts of salaries for each joining year.” In N325, if the input In1 and the input In2 are interchanged, the process target and the process condition are reversed, so that an appropriate output cannot be obtained. Similarly, in N333, if the input In3 and the input In4 are interchanged, an appropriate output cannot be obtained.

If the order of inputting the process target data and the process condition data is interchanged as described above, an appropriate output cannot be obtained in the AND nodes such as N325 and N333. In other words, the AND node is dependent on the input order thereof.

In FIG. 5, an input In5 and an input In6 are input to N326 that is the OR node. The results calculated by the paths of N323 to N325 are input in the input In5. The results calculated by the paths of N333 to N335 are input in the input In6. Since these two paths only differ in the order of the calculation process for the average values and the filtering process, the results calculated by the two paths are the same. Therefore, in FIG. 5, N325 is connected to the input In5 and N335 is connected to the input In6, but even if the nodes connected to the input In5 and the input In6 are interchanged, the results obtained are the same. In other words, the OR node is not dependent on the input order thereof.

In this case, in the directed graph as shown in FIG. 5, in the case where the feature of each node is calculated using the neural network, the neural network suitable for calculating the feature is different between the case where the target node is a node that is dependent on the input order thereof and the case where the target node is a node that is not dependent on the input order thereof. As described above, the first neural network process unit NN1 is suitable for calculating the feature for the AND node that is dependent on the input order thereof. On the other hand, the second neural network process unit NN2 is suitable for calculating the feature for the OR node that is not dependent on the input order thereof.

### [1-4. Calculation of Feature in Query Processing Execution]

A method for calculating a feature in the query processing execution will be described with reference to FIG. 6. FIG. 6 is a flowchart for executing a query processing in a system according to an embodiment. The operation in the flowchart shown in FIG. 6 is started when the host 20 issues a command to the database management system 10. In this flow chart, the calculation of the feature and the selection of the node for calculating the feature are executed by the feature calculation unit 340, the generation and modification of the directed graph is executed by the directed graph generation unit 320, and the other operations are executed by the control unit 330. In the case where these functional units are realized by a single data processing apparatus, the operations shown in FIG. 6 are executed by one or more processors included in the data processing apparatus.

As shown in FIG. 6, the control unit 330 acquires information related to the query included in the command based on the command issued from the host 20 (S601; Query). Next, the directed graph generation unit 320 creates the initial directed graph (FIG. 3) based on the content defined by the query, and performs the logical deformation on the directed graph to generate the directed graphs shown in FIG. 4 and FIG. 5 (S602; AND OR Graph).

Next, the feature calculation unit 340 selects the target node for which the feature is to be calculated (S603; Node). In S603, the nodes are selected in order starting from the node for which the input has been determined. For example, in the case of FIG. 5, N321 or N331 is first selected. Since the output of each node is executed after the feature of each node is determined, N322 is not selected unless the feature of N321 has been calculated. Similarly, N332 is not selected unless the feature of N331 has been calculated. N333 is not selected unless both the feature of N322 and the feature of N332 have been calculated.

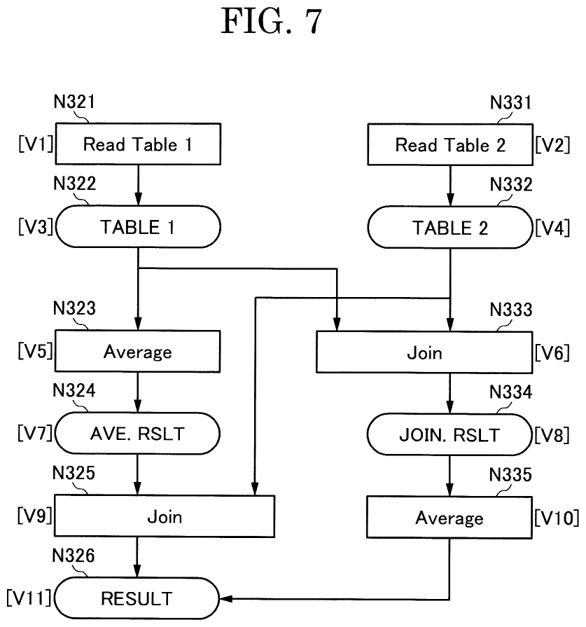

FIG. 7 is a diagram showing a result of calculating a feature of each node in a directed graph according to an embodiment. In FIG. 7, [V #] (#is a natural number) described next to each node indicates the order in which the features are calculated. That is, in FIG. 7, it means that the features are calculated in the order of N321, N331, N322, N332, N323, N333, N324, N334, N325, N335, N326. However, as described above, the calculation of the feature may be performed in order starting from the node for which the input has been determined, and is not limited to this example.

Next, as shown in FIG. 6, the control unit 330 determines whether the node selected by S603 is the AND node or the OR node (S604; AND?). If the selected node is the AND node (“Yes” in S604), the control unit 330 calculates the feature of the selected AND node using the first neural network process unit NN1 (S605; NN1). On the other hand, if the selected node is the OR node (“No” in S604), the control unit 330 calculates the feature of the selected OR node using the second neural network process unit NN2 (S606; NN2).

As described above, the feature of the AND node in S605 is calculated by inputting the feature of the OR node to be input to the selected AND node to the first neural network process unit NN1 except for N321 and N331 which have no input from the OR node. For example, in FIG. 5, in the case where the feature is calculated for joining process of N325, the feature of N325 (AND node) is calculated by inputting the features of N324 (OR node) and N332 (OR node) into the first neural network process unit NN1.

Similarly, the feature of the OR node in S606 is calculated by inputting the feature of the AND node to be input to the selected OR node to the second neural network process unit NN2. For example, in FIG. 5, in the case where the feature is calculated for the final result of N326, the feature of N326 (OR node) is calculated by inputting the features of N325 (AND node) and N335 (AND node) into the second neural network process unit NN2.

After S605 or S606, the control unit 330 determines whether the features for the respective nodes have been calculated (S607; Finish?). If the features have been calculated for all the nodes shown in FIG. 5 (“Yes” in S607), the control unit 330 executes the query processing (S608; Exe. Query). On the other hand, if the features have not been calculated for all the nodes shown in FIG. 5 (“No” in S607), the control unit 330 returns to S603 to select the next target node. When the query processing is executed in S608, the control unit 330 transmits to the host 20 that the query processing has been executed via the host interface 310 (S609; Rep. Query Result).

### [1-5. Query Processing Optimization Using Features]

In the case where the command from the host 20 includes optimization of the method for executing the query processing, the control unit 330 determines an appropriate process path based on the calculated features of the respective nodes. Specifically, the control unit 330 compares the feature calculated for at least one of N323 to N325 and the feature calculated for at least one of N333 to N335 to select the appropriate path. For example, by comparing the features, the control unit 330 may select a path with a high process rate and may select a path with a smaller load on the process device (e.g., used memory capacity, power, and usage fees of servers, etc.).

For example, the control unit 330 predicts a process cost for calculating the process result corresponding to the AND node based on the feature of the AND node included in the directed graph. Specifically, the control unit 330 can predict the process costs of the calculation process for the average values (N335) and the joining process (N325), respectively, based on the features of N333 and N325 that are the AND nodes. If the calculation process for the average values is lower than the joining process in the process costs, the control unit 330 selects the paths of N323 to N325. On the other hand, if the joining process is lower than the calculation process in the process costs for the average values, the control unit 330 selects the paths of N333 to N335.

In addition to selecting a path, the control unit 330 may provide various functions using calculated features. For example, the control unit 330 may provide a function of predicting a process cost for obtaining a process result corresponding to the OR node based on the feature of the OR node, and notifying the user of predicted costs in advance.

For example, the control unit 330 may provide a function of calculating a scheduling priority when executing the process of the AND nodes based on the feature of the AND node. For example, the scheduling priority means determining which query processing is to be executed first when a plurality of different query processing requests is received at the same timing.

As described above, according to the database management system 10 of the present embodiment, in the directed graph, the calculation of the feature for the AND node that is dependent on the input order thereof and the calculation of the feature for the OR node that is not dependent on the input order thereof are processed by a neural network suitable for each, whereby the feature suitable for each node can be calculated.

### 2. Second Embodiment

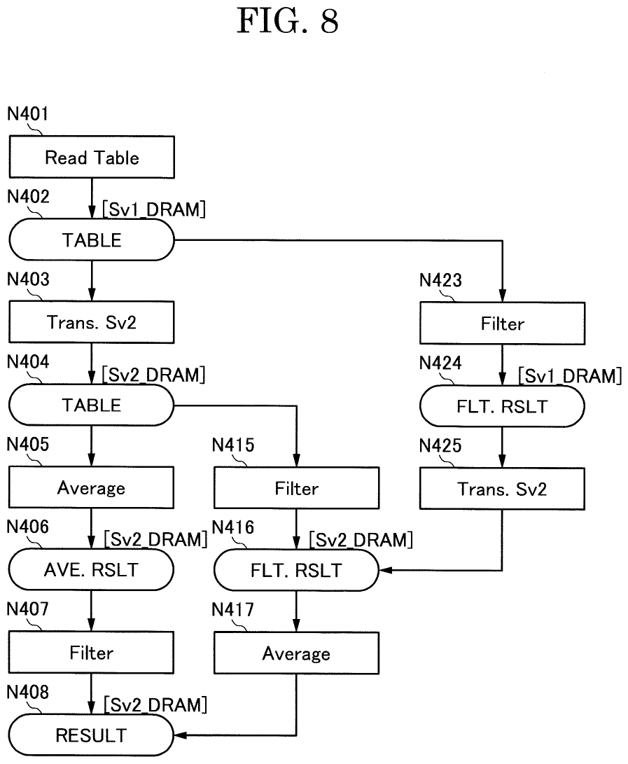

A database management system 10 according to a second embodiment will be described with reference to FIG. 8. The database management system 10 according to the second embodiment is similar to the database management system 10 according to the first embodiment. In the following description, descriptions of the same configuration as that of the database management system 10 according to the first embodiment will be omitted, and differences between them will be mainly described. With respect to the database management system 10 according to the second embodiment, the overall configuration of the database management system and the configuration of the feature calculation unit are similar to those of the first embodiment.

### [2-1. Directed Graph]

A directed graph according to the present embodiment will be described with reference to FIG. 8. The directed graph shown in FIG. 8 is a directed graph in the case where a physical deformation is executed to the directed graph to which the logical deformation is applied (see FIG. 4).

The physical deformation means a deformation of the directed graph to which the deformation rule is applied regarding which data processing apparatus executes the process of the directed graph, which storage device stores data obtained as a result of the process, and the like. In the physical deformation, the “physical property” representing information such as data processing apparatus that executes the process and a storage device that stores a result of the process is added to the node, and the directed graph is further developed according to the physical property. In this case, the plurality of paths in which the order of each AND is changed is also derived to obtain a logically equivalent final result. The path when the physical deformation is executed for both paths in the directional graph shown in FIG. 4 is diverse. Therefore, FIG. 8 exemplifies the case where the paths of N313 to N315 of the directed graph shown in FIG. 4 and the final result are stored in the second server 200.

As described above, the “physical property” is information indicating the attribute of the output data of the AND node, which defines how the output data is physically stored. In the case of FIG. 8, the plurality of paths is derived in consideration of the case in which each process is executed by the first server 100 or the second server 200.

As shown in FIG. 8, since the order of the read operation on the table cannot be changed, similar to N201 and N202 of FIG. 3 and N301 and N302 of FIG. 4, the read operation on the table (N401; Read Table) is executed and the read data (N402; TABLE) is stored in the DRAM 120 of the first server 100. In FIG. 8, a physical property indicated by parentheses is added on the target node. As shown in FIG. 8, for example, in N402, data is stored in the DRAM 120 of the first server 100 ([Sv1_DRAM]).

Since the data stored in the DRAM 120 may be processed by the first server 100 or the second server 200, the output from N402 branches.

First, the case where the process is executed by the second server 200 will be described. The data stored in the DRAM 120 is transferred to the second server 200 (N403; Trans. Sv2). The transferred data is stored in the DRAM 220 of the second server 200 as a result of the transfer process (N404; TABLE, [Sv2_DRAM]). The data is transferred from the DRAM 220 to the CPU 210.

Since the paths of N405 to N408 in FIG. 8 are the same as the paths of N303 to N306 shown in FIG. 4, the description will be omitted. Similarly, since the paths of N415 to N417 in FIG. 8 are the same as the paths of N313 to N315 shown in FIG. 4, the description will be omitted. In addition, the result of calculating the average values in N406 and the result of the filtering process in N416 are both stored in the DRAM 220 of the second server 200 ([Sv2_DRAM]).

Next, the case where the process is executed by the first server 100 will be described. In this case, the data stored in the DRAM 120 is transferred to the CPU 110. The CPU 110 executes the filtering process on the data only in the case where a certain condition is included in a certain range (N423; Filter). The filtered data is stored in the DRAM 120 as a result of the filtering process (N424; FLT. RSLT, [Sv1_DRAM]).

The data stored in the DRAM 120 is transferred to the second server 200 (N425; Trans. Sv2). The transferred data is stored in the DRAM 220 of the second server 200 as a result of the transfer process (N416; FLT. RSLT, [Sv2_DRAM]). In this data transfer, data may be directly transferred from the CPU 110 of the first server 100 to the CPU 210 of the second server 200 in FIG. 8.

Even if the output branched from N402 passes through N403, N404, N415, and N416 or the output passes through N423, N424, N425, and N416, the filtering process is executed before the calculation of the average values, so that N416 (OR node) is the result obtained by the logically equivalent process.

For the directed graph shown in FIG. 8, the control unit 330 calculates the feature of each node in the method shown in FIG. 6, and determines an appropriate process path based on the calculated feature of each node. Specifically, the control unit 330 compares the feature calculated for at least one of N405 to N407, the feature calculated for at least one of N415 to N417, and the feature calculated for at least one of N423 to N425 to select an appropriate path. For example, by comparing the features, the control unit 330 may select a path with a high process rate and may select a path with a smaller load on the process device (e.g., used memory capacity, power, and usage fees of servers, etc.).

For example, the control unit 330 decides to select the calculation results of the OR node N416 based on which process corresponds to which AND node based on the features of N415 and N425. More specifically, the feature of N415 includes information relating to the cost of transferring the table to the second server 200 and the cost of performing the filtering process by the second server 200. The feature of N425 includes the cost of performing the filtering process by the first server 100 and the cost of transferring the filtered result to the second server 200. Therefore, as described above, by selecting which AND node is to be executed based on the features of N415 and N425, it is possible to determine which of the first server 100 and the second server 200 executes the filtering process. In this case, the first server 100 may be referred to as a “first data processing apparatus.” The second server 200 may be referred to as a “second data processing apparatus.”

Although the above-described paths are logically equivalent, the process speed and the process amounts of the CPU may differ depending on the order of the process and the servers in which the process is executed. Therefore, when the control unit 330 selects a path, it is possible to optimize the method for executing the query processing by using information regarding the performance of the servers in addition to the features of the nodes. In addition, when calculating the features of the respective nodes, information regarding the performance of the servers may be input to the AND node feature calculation unit 341 and the OR node feature calculation unit 342 in advance.

As described above, according to the database management system 10 of the present embodiment, in addition to the effects similar to those of the database management system 10 of the first embodiment, it is possible to realize optimization of the process path from among a plurality of devices.

Although the present disclosure has been described above with reference to the drawings, the present disclosure is not limited to the embodiments described above and can be modified as appropriate without departing from the spirit of the present disclosure. For example, the addition, deletion, or design change of components as appropriate by those skilled in the art based on a database management system of the present embodiment are also included in the scope of the present disclosure as long as they are provided with the gist of the present disclosure. Furthermore, each of the embodiments described above as an embodiment of the present invention can be appropriately combined and implemented as long as no contradiction is caused.

Further, it is understood that, even if the effect is different from those provided by each of the above-described embodiments, the effect obvious from the description in the specification or easily predicted by persons ordinarily skilled in the art is apparently derived from the present disclosure.

What is claimed is:

1. A database management system managing a database comprising:
a processor; and
a memory,
wherein
the processor is configured to execute a query processing to the database using a directed graph according to a query received from a host, the directed graph being created based on the query,
the directed graph includes:
one or more first nodes corresponding to a process included in the query processing;
one or more second nodes corresponding to a process result of the first node; and
an edge indicating an input and an output to the first node and the second node,
the processor is configured to:
calculate features of each of the first node and the second node;
calculate the feature of the first node by inputting the feature of the second node to be input to the first node to a first neural network that is dependent on an input order of the first node; and
calculate the feature of the second node by inputting the feature of the first node to be input to the second node to a second neural network that is not dependent on an input order of the second node.

2. The database management system according to claim 1, further comprising a first data processing apparatus and a second data processing apparatus configured to execute the query processing,
wherein the processor is configured to determine whether a process in the first node is executed by the first data processing apparatus or the second data processing apparatus based on the feature of the first node calculated by the first neural network.

3. The database management system according to claim 1, wherein,
the first node includes a third node and a fourth node,
the edges to the second node are connected from the third node and the fourth node in the directed graph,
the processor is configured to:
calculate a feature of the third node and a feature of the fourth node;
calculate the feature of the third node by inputting the feature of the second node to be input to the third node to the first neural network;
calculate the feature of the fourth node by inputting the feature of the second node to be input to the fourth node to the first neural network; and
determine whether the query processing is executed by the third node or the fourth node based on the feature of the third node and the feature of the fourth node.

4. The database management system according to claim 1, wherein the processor is configured to calculate a process cost in order to obtain a process result corresponding to the second node based on the feature of the second node calculated by the second neural network.

5. The database management system according to claim 1, wherein the process cost includes at least one of a process time in the first node and a time and a memory capacity used in the second node.

6. The database management system according to claim 1, wherein the processor is configured to determine a priority of a process calculating a process result corresponding to the first node based on the feature of the first node calculated by the first neural network.

7. The database management system according to claim 1, wherein
the first neural network is an order dependent neural network, and
the second neural network is an order invariant neural network.

8. The database management system according to claim 1, wherein
the first neural network is a Feedforward Neural Network, and
the second neural network is a Graph Attention Network.

9. A method for executing a query processing to a database using a directed graph according to a query received from a host, wherein
the directed graph includes:
one or more first nodes corresponding to a process included in the query processing;
one or more second nodes corresponding to a process result of the first node; and
an edge indicating an input and an output to the first node and the second node,
the method comprising:
creating the directed graph based on the query;
calculating features of each of the first node and the second node;
calculating the feature of the first node by inputting the feature of the second node to be input to the first node to a first neural network that is dependent on an input order of the first node; and
calculating the feature of the second node by inputting the feature of the first node to be input to the second node to a second neural network that is not dependent on an input order of the second node.

10. The method according to claim 9, further comprising determining whether a process in the first node is executed by a first data processing apparatus or a second data processing apparatus based on the feature of the first node calculated by the first neural network,
wherein the first data processing apparatus and the second data processing apparatus are configured to execute the query processing.

11. The method according to claim 9, further comprising:
calculating a feature of a third node and a feature of a fourth node;
calculating the feature of the third node by inputting the feature of the second node to be input to the third node to the first neural network;
calculating the feature of the fourth node by inputting the feature of the second node to be input to the fourth node to the first neural network; and
determining whether the query processing is executed by the third node or the fourth node based on the feature of the third node and the feature of the fourth node,
wherein,
the first node includes the third node and the fourth node, and
the edges to the second node are connected from the third node and the fourth node in the directed graph.

12. The method according to claim 9, further comprising calculating a process cost in order to obtain a process result corresponding to the second node based on the feature of the second node calculated by the second neural network.

13. The method according to claim 12, wherein the process cost includes at least one of a process time in the first node and a time and a memory capacity used in the second node.

14. The method according to claim 9, further comprising determining a priority of a process calculating the process result corresponding to the first node based on the feature of the first node calculated by the first neural network.

15. A database management system comprising:
a directed graph generating unit;
a feature calculating unit; and
a query processing executing unit configured to execute a query processing to the database according to a query received from a host,
wherein
the directed graph generating unit is configured to create a directed graph based on the query,
the directed graph includes:
one or more first nodes corresponding to a process included in the query processing;
one or more second nodes corresponding to a process result of the first node; and
an edge indicating an input and an output to the first node and the second node,
the feature calculating unit is configured to:
calculate features of each of the first node and the second node;
calculate the feature of the first node by inputting the feature of the second node to be input to the first node to a first neural network that is dependent on an input order of the first node; and
calculate the feature of the second node by inputting the feature of the first node to be input to the second node to a second neural network that is not dependent on an input order of the second node.

16. The database management system according to claim 15, further comprising a control unit,
wherein
the query processing executing unit further includes a first data processing apparatus and a second data processing apparatus,
the first data processing apparatus and the second data processing apparatus are configured to execute the query processing,
the control unit is configured to determine whether a process in the first node is executed by the first data processing apparatus or the second data processing apparatus based on the feature of the first node calculated by the first neural network.

17. The database management system according to claim 15, further comprising a control unit,
wherein,
the first node includes a third node and a fourth node,
the edges to the second node are connected from the third node and the fourth node in the directed graph,
the feature calculating unit is configured to:
calculate a feature of the third node and a feature of the fourth node;
calculate the feature of the third node by inputting the feature of the second node to be input to the third node to the first neural network; and
calculate the feature of the fourth node by inputting the feature of the second node to be input to the fourth node to the first neural network, and
the control unit is configured to determine whether the query processing is executed by the third node or the fourth node based on the feature of the third node and the feature of the fourth node.

18. The database management system according to claim 15, further comprising a control unit,
wherein the control unit is configured to calculate a process cost in order to obtain a process result corresponding to the second node based on the feature of the second node calculated by the second neural network.

19. The database management system according to claim 15, wherein the process cost includes at least one of a process time in the first node and a time and a memory capacity used in the second node.

20. The database management system according to claim 15, further comprising a control unit,
wherein the control unit is configured to determine a priority of a process calculating a process result corresponding to the first node based on the feature of the first node calculated by the first neural network.
